(19) United States
(12) Patent Application Publication
(10) Pub. No.: US 2018/0308048 A1
(43) Pub. Date: Oct. 25, 2018

(54) System and Method for Managing Returned Merchandise Using Trucks Tasked With Delivering Merchandise

(71) Applicant: Walmart Apollo, LLC, Bentonville, AR (US)

(72) Inventors: Behzad Nemati, Springdale, AR (US); Ehsan Nazarian, Rogers, AR (US)

(73) Assignee: Walmart Apollo, LLC, Bentonville, AR (US)

(21) Appl. No.: 15/960,671

(22) Filed: Apr. 24, 2018

Related U.S. Application Data
(60) Provisional application No. 62/489,103, filed on Apr. 24, 2017.

(51) Int. Cl. G06Q 10/08

(52) U.S. Cl. CPC G06Q 10/0837

(57) ABSTRACT

Systems, methods, and computer-readable storage media for identifying groups of retail locations and initiating the collection of returned goods in a group of retail locations using a transport vehicle tasked with delivering merchandise to one of the retail locations in the group. Determining when to dispatch a delivery vehicle to also collect returned goods can be based on the meeting of a group threshold regarding the returned items across all stores, or a threshold associated with a single store in the group of stores.

### BACKGROUND

### 1. Technical Field

The present disclosure relates to assigning transports tasked with delivering merchandise to also retrieve returned merchandise, and more specifically to determining when a transport which is already tasked to deliver merchandise should be further tasked to retrieve the returned merchandise from one or more locations.

### 2. Introduction

The system for delivering goods from manufacturers to retail locations generally moves products from the manufacturer to distribution centers of a retailer, then from the distribution centers to the retail locations Likewise, systems for collecting returned items generally move the returned goods from retail locations back to distribution centers, at which time the returned products can then be redistributed to other retail locations, returned to the manufacturer, or disposed of. While both the distribution of items to retail locations and the collection of returned items from those retail locations use trucks or other shipping mechanisms, separate systems are often implemented for the delivering of goods and the collecting of returned items. Such distinct systems for delivering merchandise and collecting returned goods can result in simplicity, for example, in dispatching trucks to deliver goods while dispatching distinct trucks to collect returned goods. However, the same system creates waste in the form of empty trucks being driven to/from the distribution centers and the retail locations.

### SUMMARY

An exemplary method for performing concepts disclosed herein can include: as items are returned at a plurality of stores co-located within a contiguous geographic area: receiving, at a server, a first report of first returned items at a first store in a plurality of stores, the first report transmitted to the server upon any item being returned to the first store; receiving, at the server, a second report of second returned items at a second store in the plurality of stores, the second report transmitted to the server upon any item being returned to the second store; retrieving a list of dimensions for items listed in the first report and the second report, the list of dimensions comprising volume and weight for each item in the first returned items and the second returned items; calculating, via a processor on the server and based on the first report, the second report, and the list of dimensions, a total volume of the first returned items and the second returned items; calculating, via a processor on the server and based on the first report, the second report, and the list of dimensions, a total weight of the first returned items and the second returned items; when at least one of the total volume of the first returned items and the second returned items, the total weight of the first returned items and the second returned items, and a total number of the first returned items and the second returned items exceed a threshold, initiating a returned item collection process, the returned item collection process comprising: generating an instruction for a transport vehicle delivering goods to any store in the plurality of stores to collect returned items from each store in the plurality of stores; and transmitting the instruction to the transport vehicle.

An exemplary system configured to perform concepts disclosed herein can include: a processor; and a computer-readable storage medium having instruction stored which, when executed by the processor, cause the processor to perform operations comprising: monitoring real-time inventory return data from a plurality of stores co-located within a contiguous geographic area; as the real-time inventory data is received, comparing a total of returned items across the plurality of stores to a total returned items threshold; and upon determining that the total of returned items exceeds the total returned items threshold: generating an instruction for a transport vehicle delivering goods to any store in the plurality of stores to collect returned items from each store in the plurality of stores; and transmitting the instruction to the transport vehicle.

An exemplary non-transitory computer-readable storage medium can have stored instructions which include: monitoring real-time inventory return data from a plurality of stores co-located within a contiguous geographic area; as the real-time inventory data is received, comparing a total of returned items across the plurality of stores to a total returned items threshold; and upon determining that the total of returned items exceeds the total returned items threshold: generating an instruction for a transport vehicle delivering goods to any store in the plurality of stores to collect returned items from each store in the plurality of stores; and transmitting the instruction to the transport vehicle.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates exemplary collection of returned goods across multiple stores using a delivery transport vehicle;

FIG. 2 illustrates a network architecture configured to assign transport vehicles to collect returned goods;

FIG. 3 illustrates a decision tree a server can follow to determine if a delivery transport vehicle should be routed to collect returned goods;

FIG. 4 illustrates an exemplary method embodiment; and

FIG. 5 illustrates an example computer system which can be used to practice the invention.

### DETAILED DESCRIPTION

Implementations of the concepts disclosed herein (whether those implementations be systems, methods, processes, computer-readable storage mediums, etc.) can result in improved shipping and transportation systems. Specifically, by using the same mechanisms to both deliver merchandise to retail locations and to collect returned goods from those retail locations, fewer transports will be empty while moving between retail locations and distribution centers. In addition, systems configured as described herein can avoid waste associated with collecting returned goods on a fixed, periodic basis, and instead can dynamically assign transports to collect returned goods from retail locations as needed by the retail locations.

As used herein, the term “retailer” or “retail marketplace” may refer to an entity that offers products for sale to consumers, sometimes referred to as end users, on a retail level. The products offered for sale by retailers may include its own products, products purchased from partners, or products offered by partners for sale even though title to the products has not been formally transferred to the retailer. A store, or retail location, as used herein is a “brick-and-mortar” store, meaning that consumers may visit the location to select merchandise for purchase.

As used herein, the term “distribution center” may refer to an operation that includes a warehouse for storing and managing inventory of products. In some configurations, the distribution centers may physically manage inventory of product offered for sale by others, including partners, third party suppliers (including e-commerce suppliers), and retailers. That is, distribution centers may fulfill shipping orders from retailers and partners.

As used herein, transports and transport vehicles are mechanisms used for moving goods between distribution centers and retail locations. While in some cases this can be a direct distribution (i.e., a truck moves goods directly from the distribution center to the retail location), in other cases the distribution can be indirect (i.e., a train moves goods from a. distribution center to an intermediate distribution center, where a truck receives the goods and delivers them to retail locations). Exemplary transports can therefore include trucks and trains, as well as air transport such as planes and aerial drones. Automated, self-driving trucks and/or drones are likewise within the scope of this disclosure.

Consider the following example. Several retail locations have been grouped together such that when the combined group has returned merchandise above a threshold value (i.e., enough to fill a truck), the next transport vehicle delivering merchandise to any store in the grouped retail locations will collect the returned goods from each store in the group. To identify when the group of stores has a returned inventory meriting the assigning of a transport vehicle to pick up the goods, a central server can collect returned goods information from each store. The returned goods information received by the central server can, for example, be an electronic signal transmitted from a cash register or other device at the retail location, where the electronic signal identifies the type of item being returned and the quantity of items being returned. The signal can likewise identify other qualities of the returned goods, such as the quality, if the goods were used/opened, if the goods are seasonal or otherwise expired, geographically specific, etc. When the total number of returned items for the group exceeds a predefined threshold, the central server can assign a transport vehicle (which is already scheduled to deliver goods to a retail store within the group of stores) to collect returned goods from each store in the group of stores.

The predefined threshold can, for example, be established based on the number of returned items which have been received at the group of retail stores. However, in other configurations, the predefined threshold can be determined using alternative mechanisms. For example, the predefined threshold can be based on a total weight of returned goods. In this example, each time a product is returned to a store, the store scans a barcode or otherwise identifies the type of product being received into a computer system. The computer system then looks up the weight for the product and sends to a central server the number of items being returned, the type of products being returned, and the weight of the returned items. When the weight of returned items for all of the stores in the group of stores collectively exceeds (or begins to approach) a predefined weight threshold, a transport already delivering goods to one of the stores in the group is assigned to retrieve the returned merchandise from the entire group. In some cases, the predefined weight threshold can be determined based on the specific capacities of the transports assigned to deliver goods, the capacities of pallets or pallet loaders to carry the goods to the transport, etc.

In another example, the predefined threshold can be based on the total volume of the returned goods. As with weight, each time a product is returned to a store, the store scans a barcode or otherwise identifies the type of product being received into a computer system. The computer system then looks up the volume for the product and sends to a central server the number of items being returned, the type of products being returned, and the volume of the returned items. When the volume of returned items for all of the stores in the group of stores collectively exceeds (or begins to approach) a predefined volume threshold, a transport already delivering goods to one of the stores in the group is assigned to retrieve the returned merchandise from the entire group. In some cases, the predefined volume threshold can be determined based on the specific capacities of the transports assigned to deliver goods, the capacities of pallets or pallet loaders to carry the goods to the transport, etc. The predefined threshold can also be a combination of factors, such as a combination of the weight and volume of returned goods, the height/width of the items individually or when stacked, etc. Also, the central server may retrieve the product qualities in some embodiments.

The triggering of a transport to begin collecting returned goods can, in some cases, be triggered by a single store exceeding store specific thresholds. For example, if a store has a limited amount of space for returned items and is approaching, or exceeding, that limit, a transport can be assigned to collect returned goods from that store, even if thresholds associated with the overall group of stores have not been met. Consider if a group has a volume threshold corresponding to a single, standard, 40 foot (12.2 m) shipping container (having interior dimensions of Length=39′ 6.5″ (12.056 m), Width=7′ 8 ¼″ (2.347 m), Height=8′ 5 ½″ (2.684 m)), the group threshold would be the 2,684 cubic feet (76.0 cubic meters). If an individual store in that group only has space for 1,200 cubic feet (33.98 cubic meters), then when the volume of returned goods at the store exceeds (or approaches) 1,200 cubic feet (33.98 cubic meters), a truck can be assigned to retrieve the goods. In such a case, the truck assigned to collect the returned goods can be tasked with retrieving goods only from that store, or can be tasked to retrieve goods from other stores in the group of stores, despite the threshold associated with the entire group not being met.

Which transport is selected to recover returned merchandise from the group of stores can be based on temporal considerations. For example, once a threshold is met, the next transport delivering merchandise to any store in the group of stores can be assigned to collect the returned goods from all of the stores in the group, then return those goods to a distribution center for re-entry into supply chain distribution. In other circumstances, the transport selected can be based on volume capacity, fuel-efficiency, horse-power (particularly where thresholds are based on weight), speed, safety record, etc. In yet other configurations, the transport can be selected based on a combination of two or more categories (i.e., the next transport leaving which has a threshold volume, or a transport having a specified volume and a fuel-efficiency).

Selection of which stores are grouped together for collecting returned goods is performed via a computing system configured to select groups of stores based on historical sales, returned merchandise information, costs to store returned items in the retail locations, costs to store returned items in a distribution center, and/or costs to collect the returned items. More specifically, the selection occurs based on real-time data collected in the form of electronic signals received over a network (such as the Internet), where the electronic signals indicate data about items being returned. In some configurations the computing system can define groups of stores on a periodic basis (i.e., every six months, or once a year), whereas in other configurations the groups are dynamically established in real-time by the computing system. That is, as electronic signals are received which reflect the real-time returns of merchandise in each store in many stores, the computing system is evaluating which stores, and which possible groups of stores, are approaching thresholds for collecting returned goods. When one of those thresholds is met, the computing system establishes a group based on that threshold being met and assigns a transport unit delivering goods to a store in that newly established group. After the transport collects the returned goods and delivers them to the distribution center, the group which was established can be disbanded.

Factors which can be used by the computing system in making the groups can include the geographic locations of the stores. For example, if the stores are co-located with a geographic region, they may be selected. The stores can also be selected based on the rates of returns collected at the stores. For example, based on historical data, the rates of returned items indicate that two stores which are geographically near to one another may together fill one transport each week, the system can group the stores together. Other factors which can be used to group stores are the types of goods carried by the stores, the size of the stores, the size of delivery transport vehicles to stores, costs for delivery/collection for a store (i.e., tolls for roads, gas, etc.), which store in the group is receiving merchandise next, and/or seasonal data specific to a store.

Once a transport is assigned to collect the goods from a group of stores after the delivery transport vehicle delivers, the computing system can also determine the order in which the stores are to be visited to ensure maximum efficiency in collecting the returned goods. Such determinations can be based on costs of moving the transport between locations, but can also be based on the type of products being collected at each store. For example, if one store in a group of stores has food products which have been returned, the transport may be directed to collect those food products last, thereby keeping the food products in a truck (or other transport) for as little time as possible.

The concepts disclosed herein can also be used to improve the computing systems which are performing, or enabling the performance, of the disclosed concepts. For example, information associated with routes, deliveries, truck cargo, distribution center inventory or requirements, retail location inventory or requirements, etc., can be generated by local computing devices. In a standard computing system, the information will then be forwarded to a central computing system from the local computing devices. However, systems configured according to this disclosure can improve upon this “centralized” approach.

One way in which systems configured as disclosed herein can improve upon the centralized approach is combining the data from the respective local computing devices prior to communicating the information from the local computing devices to the central computing system. For example, a truck traveling from a distribution center to a retail location may be required to generate information about (1) the route being travelled, (2) space available in the truck for additional goods, (3) conditions within the truck, etc. Rather than transmitting each individual piece of data each time new data is generated, the truck processor can cache the generated data for a period of time and combine the generated data with any additional data which is generated within the period of time. This withholding and combining of data can conserve bandwidth due to the reduced number of transmissions, can save power due to the reduced number of transmissions, and can increase accuracy due to holding/verifying the data for a period of time prior to transmission.

Another way in which systems configured as disclosed herein can improve upon the centralized approach is adapting a decentralized approach, where data is shared among all the individual nodes/computing devices of the network, and the individual computing devices perform calculations and determinations as required. In such a configuration, the same truck described above can be in communication with the retail location and the distribution center, and can make changes to the route, destination, pickups/deliveries, etc., based on data received and processed while enroute between locations. Such a configuration may be more power and/or bandwidth intensive than a centralized approach, but can result in a more dynamic system because of the ability to modify assignments and requirements immediately upon making that determination. In addition, such a system can be more secure, because there are multiple points of failure (rather than a single point of failure in a centralized system).

It is worth noting that a “hybrid” system might be more suitable for some specific configurations. In this approach, a part of the network/system would be using the centralized approach (which can take advantage of the bandwidth savings described above), while the rest of the system is utilizing a de-centralized approach (which can take advantage of the flexibility/increased security described above). For instance, the trucks could be connected to a central server at the distribution center, while that server is connected to a decentralized network of store computers.

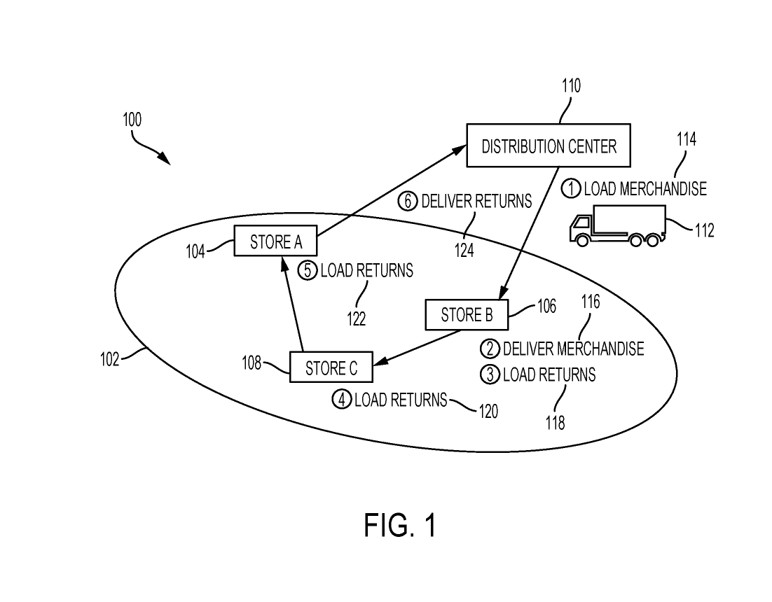

These and other variations shall be further elaborated upon as the illustrations are described. The disclosure now turns to FIG. 1, which illustrates exemplary collection of returned goods 100 across multiple stores 104-108 using a delivery transport vehicle 112. In this example, a server or other computing system has determined that the group of stores 102 which includes store A 104, store B 106, and store C 108 have a sufficient number of returned goods to merit assigning a transport vehicle to collect the returned goods. To avoid moving an empty transport vehicle unnecessarily, the system identifies a transport vehicle 112 already assigned to deliver merchandise from a distribution center 110 to a retail store 106, and further assigns that vehicle 112 to collect the returned goods from the stores 104-108 in the group 102.

Once the transport vehicle 112 has the assignment, the transport vehicle is loaded 114 with the merchandise which it needs to deliver to one or more retail stores (in this example, store B 106) in the group of stores 102. The transport vehicle 112 travels from the distribution center 110 to the store 106 where the merchandise is being delivered, then delivers the merchandise 116 and loads returned goods 118 into the transport. The transport vehicle 112 then moves to a next store in the group of stores 102 (in this example, store C 108), where returned goods from store C 108 are loaded into the transport 120. The transport vehicle 112 then moves to the final store in the group of stores (in this example, store A 104), where returned goods from store A 104 are loaded into the transport 122. At this point, having visited all of the stores 104-108 in the group 102 of stores, the transport 112 returns to the distribution center 110 and delivers the returned goods 124. The distribution center 110 can then process the returned goods, reintroduce them into the supply chain, etc., as required.

Please note that the number of stores 104-108 illustrated as making a group of stores 102 is not limited to three. In addition, in some configurations, the group of stores can be as few as a single store, where a transport vehicle 112 is also used to collect returned merchandise from that store. However, in preferred configurations, the group of stores 102 contains at least two stores. Also, the transport vehicle may make deliveries to one and pick up returns from or more of the stores.

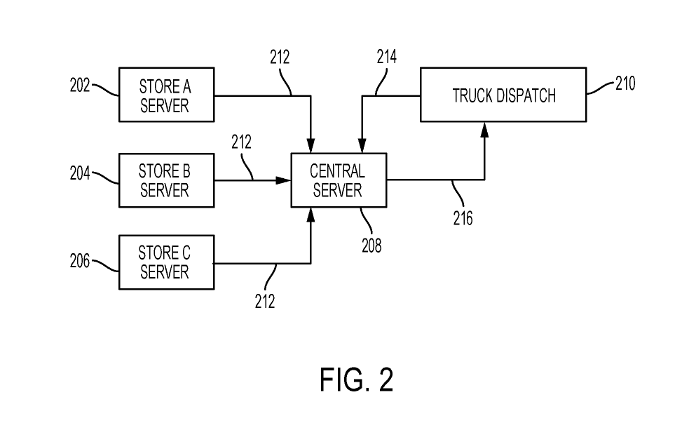

Assigning the transport vehicle 112 to collect the returned merchandise can require real-time data regarding the amount of inventory which has been received at each store 104-108 in the group of stores 102. In addition, such assignment may require real-time data on when transports are leaving to deliver merchandise to the stores 104-108. To accomplish these tasks, FIG. 2 illustrates an exemplary network architecture configured to assign transport vehicles to collect returned goods. In this example, a central server 208 is receiving real-time updates 212 from servers 202-206 associated with the stores 104-108 illustrated in FIG. 1. The updates 212 provide information to the central server 208 regarding what types of items are being returned and the number of those items. The updates 212 can also include volume, weight, expiration, seasonal, used/new, or other pertinent information associated with the returned goods. In some configurations, the central server 208 can look up information regarding the weight, volume, expiration, geographic, and/or other factors about the returned product from a database (rather than having such data delivered with the real-time returned goods information 212 by the store servers 202-206).

The central server 208 also receives real-time updates 214 from a truck dispatch 210 (or other transport service), indicating when transports are scheduled to deliver merchandise to respective stores. The central server 208, upon identifying that either the returned goods from the group of stores 102 exceeds (or is about to exceed) a group threshold that the returned goods from a single store in the group of stores 102 exceeds (or is about to exceed) a store threshold, assigns 216 a transport vehicle to collect the returned goods from the group of stores 102. Assigning 216 a transport vehicle can, for example, involve sending a signal to a transmission dispatch service 210 which sends an email, generates an assignment log, sends an automated radio transmission signal, or otherwise communicates assignments to drivers and/or the transport vehicles. In some configurations, if a threshold is met after a transport vehicle has left the distribution center, but before the transport vehicle has left its delivery location, the truck dispatch (aka, transmission dispatch service, or dispatch service) 210 can radio or otherwise assign the transport vehicle to collect the returned goods while the transport vehicle is already delivering merchandise.

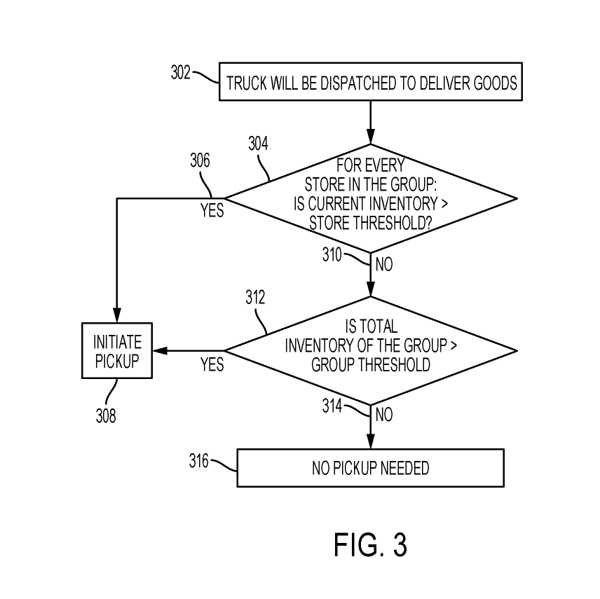

FIG. 3 illustrates an exemplary process the server 208 can follow to determine if a transport vehicle should be routed to collect returned goods. In this example, the server 208 has already received a notification 214 that a truck will be dispatched to deliver goods 302. The server 208 may, for every store in a group of stores, determine if the current store inventory of returned goods is greater than that store's capacity for storing returned goods (i.e., the store's threshold) 304. If so, the server 208 initiates a pickup 308 of the returned goods for the group. If not 310, the server determines if the total inventory for returned goods in the group of stores exceeds a group threshold 312. If so, the server 208 can also initiate the pickup 308 of the returned goods for the group. If not 314, no pickup is necessary at this time. Because real-time signals 212 are received from the servers of the stores 202-206 and the dispatch service 210, these determinations 304, 312 can be made in real-time as each signal 212 is received from the servers 202-206 and/or each time a transport vehicle is being dispatched. If the transport vehicle 112 is making a delivery to a store that has not yet reached a threshold, it may still pick up the return items from that store.

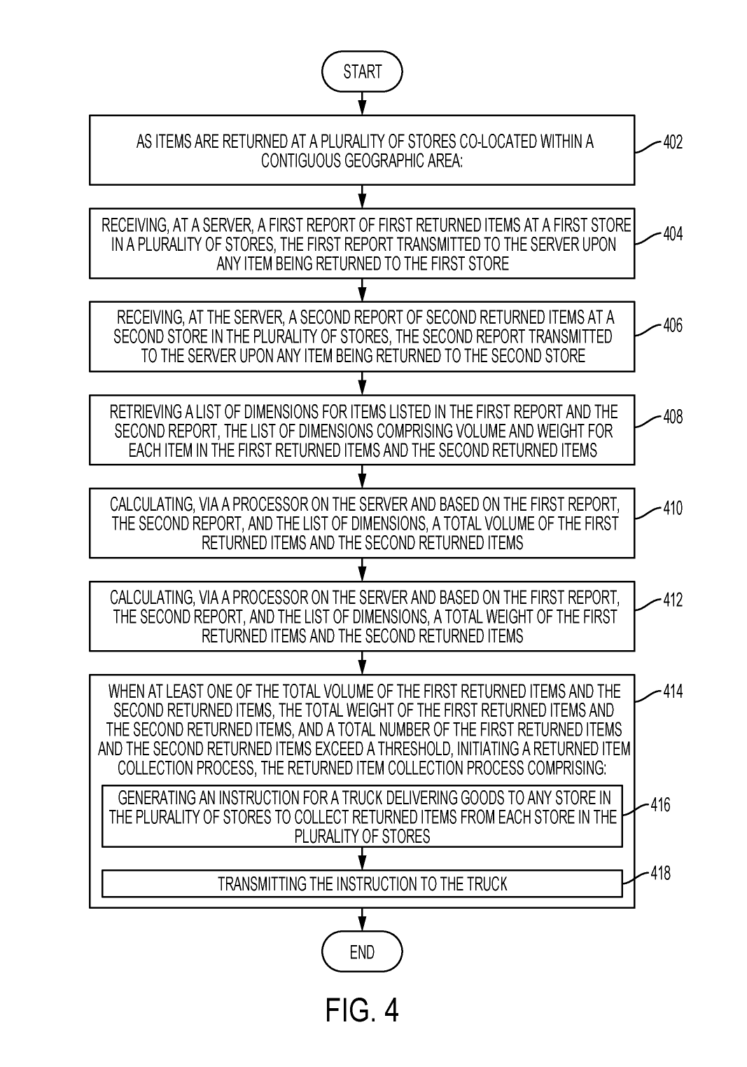

FIG. 4 illustrates an exemplary method embodiment of performing concepts disclosed herein. The steps outlined herein are exemplary and can be implemented in any combination thereof, including combinations that exclude, add, or modify certain steps. In this example, the method is performed by a server 208 as illustrated in FIG. 2. The server 208 performs actions as items are returned at a plurality of stores co-located within a contiguous geographic area (402). First, the server 208 receives a first report of first returned items at a first store in a plurality of stores, the first report transmitted to the server upon any item being returned to the first store (404). The server 208 also receives a second report of second returned items at a second store in the plurality of stores, the second report transmitted to the server upon any item being returned to the second store (406).

The server 208 retrieves a list of dimensions for items listed in the first report and the second report, the list of dimensions comprising volume and weight for each item in the first returned items and the second returned items (408). Using a processor on the server, and based on the first report, the second report, and the list of dimensions, a total volume of the first returned items and the second returned items is calculated (410). In addition, and using those same factors, a total weight a total weight of the first returned items and the second returned items is calculated (412). When at least one of the total volume of the first returned items and the second returned items, the total weight of the first returned items and the second returned items, and a total number of the first returned items and the second returned items exceed a threshold, the server 208 initiates a returned item collection process (414). The returned item collection process can include: generating an instruction for a transport vehicle delivering goods to any store in the plurality of stores to collect returned items from each store in the plurality of stores (416) and transmitting the instruction to the transport vehicle (418). As an example, the transport vehicle may be a first transport vehicle to deliver goods to any store in the plurality of stores after the determining that the total of returned items exceeds the total returned items threshold. The transport vehicle can be human controlled or autonomous.

In certain configuration, the method of FIG. 4 can be augmented to include, as the items are returned: comparing amounts of returned inventory in each store to store specific returned inventory thresholds; and upon determining that a store in the plurality of stores has an amount of returned inventory exceeding the a respective store specific returned inventory threshold for the store, initiating the returned item collection process.

Each store in the plurality of stores can, for example, be selected for inclusion in the plurality of stores based on: location within the contiguous geographic area; and a volume of expected returns at each store over a predetermined amount of time. Moreover, each store can be selected for other factors, such as carrying particular merchandise in the store. For example, stores may be selected based on those stores carrying specific third party items. In addition, the plurality of stores may be modified (i.e., a store may be added to the plurality of stores or removed from the plurality of stores) on a dynamic basis based on real-time data, or on a fixed periodic basis (i.e., re-arrange the group assignments every 3 months, or every 6 months).

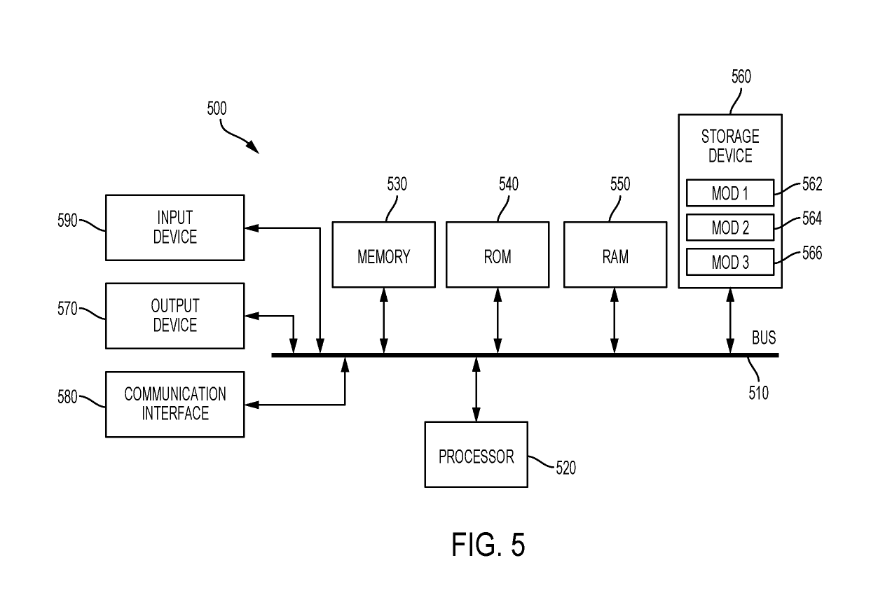

FIG. 5 illustrates an example computer system 500 which can be used to practice the invention. The exemplary system 500 includes a general-purpose computing device 500, including a processing unit (CPU or processor) 520 and a system bus 510 that couples various system components including the system memory 530 such as read only memory (ROM) 540 and random access memory (RAM) 550 to the processor 520. The system 500 can include a cache of high speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
as items are returned at a plurality of stores co-located within a contiguous geographic area:
receiving, at a server, a first report of first returned items at a first store in a plurality of stores, the first report transmitted to the server upon any item being returned to the first store;
receiving, at the server, a second report of second returned items at a second store in the plurality of stores, the second report transmitted to the server upon any item being returned to the second store;
retrieving a list of dimensions for items listed in the first report and the second report, the list of dimensions comprising volume and weight for each item in the first returned items and the second returned items;
calculating, via a processor on the server and based on the first report, the second report, and the list of dimensions, a total volume of the first returned items and the second returned items;
calculating, via a processor on the server and based on the first report, the second report, and the list of dimensions, a total weight of the first returned items and the second returned items;
when at least one of the total volume of the first returned items and the second returned items, the total weight of the first returned items and the second returned items, and a total number of the first returned items and the second returned items exceed a threshold, initiating a returned item collection process, the returned item collection process comprising:
generating an instruction for a transport delivering goods to any store in the plurality of stores to collect returned items from each store in the plurality of stores; and
transmitting the instruction to the transport.

2. The method of claim 1, further comprising:
as the items are returned:
comparing amounts of returned inventory in each store to store specific returned inventory thresholds; and
upon determining that a store in the plurality of stores has an amount of returned inventory exceeding the a respective store specific returned inventory threshold for the store, initiating the returned item collection process.

3. The method of claim 1, wherein the transport is a first truck to deliver goods to any store in the plurality of stores after the determining that the total of returned items exceeds the total returned items threshold.

4. The method of claim 1, wherein each store in the plurality of stores is selected for inclusion in the plurality of stores based on:
location within the contiguous geographic area; and
a volume of expected returns at each store over a predetermined amount of time.

5. The method of claim 4, wherein each store in the plurality of stores is further selected for inclusion in the plurality of stores based on third party items carried at each store.

6. The method of claim 1, wherein a store is added to the plurality of stores.

7. The method of claim 1, wherein the transport is autonomous.

8. A system comprising:
a processor; and
a computer-readable storage medium having instruction stored which, when executed by the processor, cause the processor to perform operations comprising:
monitoring real-time inventory return data from a plurality of stores co-located within a contiguous geographic area;
as the real-time inventory data is received, comparing a total of returned items across the plurality of stores to a total returned items threshold; and
upon determining that the total of returned items exceeds the total returned items threshold:
generating an instruction for a truck delivering goods to any store in the plurality of stores to collect returned items from each store in the plurality of stores; and
transmitting the instruction to the truck.

9. The system of claim 8, the computer-readable storage medium having additional instructions stored which, when executed by the processor, cause the processor to perform operations comprising:
as the items are returned:
comparing amounts of returned inventory in each store to store specific returned inventory thresholds; and
upon determining that a store in the plurality of stores has an amount of returned inventory exceeding the a respective store specific returned inventory threshold for the store, initiating the returned item collection process.

10. The system of claim 8, wherein the truck is a first truck to deliver goods to any store in the plurality of stores after the determining that the total of returned items exceeds the total returned items threshold.

11. The system of claim 8, wherein each store in the plurality of stores is selected for inclusion in the plurality of stores based on:
location within the contiguous geographic area; and
a volume of expected returns at each store over a predetermined amount of time.

12. The system of claim 11, wherein each store in the plurality of stores is further selected for inclusion in the plurality of stores based on third party items carried at each store.

13. The system of claim 8, wherein a store is added to the plurality of stores.

14. The system of claim 8, wherein a store is removed from the plurality of stores.

15. A non-transitory computer-readable storage medium having instructions stored which, when executed by a computing device, cause the computing device to perform operations comprising:
monitoring real-time inventory return data from a plurality of stores co-located within a contiguous geographic area;
as the real-time inventory data is received, comparing a total of returned items across the plurality of stores to a total returned items threshold; and
upon determining that the total of returned items exceeds the total returned items threshold:
generating an instruction for a truck delivering goods to any store in the plurality of stores to collect returned items from each store in the plurality of stores; and
transmitting the instruction to the truck.

16. The non-transitory computer-readable storage medium of claim 15, having additional instructions stored which, when executed by the processor, cause the computing device to perform operations comprising:
as the items are returned:
comparing amounts of returned inventory in each store to store specific returned inventory thresholds; and
upon determining that a store in the plurality of stores has an amount of returned inventory exceeding the a respective store specific returned inventory threshold for the store, initiating the returned item collection process.

17. The non-transitory computer-readable storage medium of claim 15, wherein the truck is a first truck to deliver goods to any store in the plurality of stores after the determining that the total of returned items exceeds the total returned items threshold.

18. The non-transitory computer-readable storage medium of claim 15, wherein each store in the plurality of stores is selected for inclusion in the plurality of stores based on:
location within the contiguous geographic area; and
a volume of expected returns at each store over a predetermined amount of time.

19. The non-transitory computer-readable storage medium of claim 18, wherein each store in the plurality of stores is further selected for inclusion in the plurality of stores based on third party items carried at each store.

20. The non-transitory computer-readable storage medium of claim 15, wherein a store is added to the plurality of stores.
